(19) United States
(12) Patent Application Publication
(10) Pub. No.: US 2006/0026683 A1
(43) Pub. Date: Feb. 2, 2006

(54) Intrusion protection system and method

(76) Inventor: Keng Leng Albert Lim, Tampines (SG)

Correspondence Address: HARNESS, DICKEY & PIERCE, P.L.C., P.O. BOX 828, BLOOMFIELD HILLS, MI, 48303, US

(21) Appl. No.: 11/051,795

(22) Filed: Feb. 4, 2005

(30) Foreign Application Priority Data
Jul. 30, 2004 (SG) 2004-04342-8

(51) Int. Cl. G06F 12/14

(52) U.S. Cl. 726/23

(57) ABSTRACT

An intrusion protection system and method protect host computers of a computer network from network intrusions. All inbound and outbound transmissions of individual host computers are monitored to detects any unauthorised events. The Once an unauthorised event is detected the inbound and outbound transmissions of a host computer are locked down, thereby isolating the host computer from the rest of the computer network. A global network security provider provides further security services remotely.

### FIELD OF THE INVENTION

The present invention relates to intrusion protection for a computer network, in particular to a method and system for protecting a network with multiple computers against intrusion.

### BACKGROUND

The accessing of information through the Internet, sharing of files across network, sending and receiving emails with attachments and utilising databases by way of electronic communications are now part of the daily routine for many people and businesses. Almost all electronic communication is subject to the challenge of managing the risks presented in today's cyber world effectively, to protect itself against malicious attacks and hacking threats. These malicious attacks and hacking threats are usually the result of hackers exploiting security vulnerabilities in computer software.

Commonly, security vulnerabilities proliferating in cyberspace are not new-found. Typically, most worms and viruses exploit vulnerabilities that a software vendor has already uncovered and has provided users with a patch (although there typically is a lag between the time the users, such as system administrators, get to learn of a patch and when the software vendors made the patch available). However, the main challenges arise when a day-zero attack occurs, that is when a hacker exploits a flaw that even the software vendor does not know about. Without any remedy patch available, such zero-day attacks are often highly perilous and extremely contagious. As a consequence, many applications and operating systems running at endpoints in a network are vulnerable to a continuous avalanche of probable attacks until a relevant software patch is properly and successfully installed. Thus zero-day attacks present the greatest concern in today's cyber world, especially for system and security administrators. Further, increasing numbers and seriousness of day-zero attacks and viral outbreaks demonstrate a need to secure and monitor critical endpoints in electronic communications.

One preventative measure that can be employed is to use a firewall. However, firewalls provide only limited protection. A single firewall is typically placed before a server to protect it from external attacks. In the case of hackers using deceptive packets containing a malicious application, the security is broken when the firewall is fooled into allowing the bad packets through. Furthermore, if the hacking is done from within the network, by an insider, the firewall is useless.

U.S. Pat. No. 5,440,723, issued on 8 Aug. 1995 to William C. Arnold et al., discusses computer network security preventative measures by detection of anomalous behaviour followed by taking remedial action.

U.S. Pat. No. 5,511,184, issued on 23 Apr. 1996 to Pei-Hu Lin, discusses the detection of a virus attack by write-protection of storage devices at boot time and making integrity checks on system modules, device drivers and application programs.

U.S. Pat. No. 5,956,481, issued on 21 Sep. 1999 to James E. Walsh, discusses open-file hook intercept techniques for detecting virus presence in files. In these documents, detection is the key component to their functionality well-being. However, during a day-zero attack, it is usually impossible to detect, not to mention to take remedial action, without full knowledge of the security vulnerability that is exploited.

### SUMMARY

According to one aspect of the present invention, there is provided an intrusion protection system (IPS) for protecting a computer network having a plurality of host computers from computer network intrusions. The system comprises: an intrusion protection system controller; and a plurality of IPS engines, controlled by the intrusion protection system controller, for monitoring and controlling inbound and outbound transmissions to the host computers. The IPS engines reside in respective ones of the host computers, and are arranged to isolate the transmissions of their host computers from the computer network automatically.

According to another aspect of the present invention, there is provided a method of protecting a computer network having a plurality of host computers from computer network intrusions. The method comprises: monitoring inbound and outbound transmissions of the host computers, detecting unauthorised events from said transmissions and isolating a host computer from the computer network. Monitoring inbound and outbound transmissions of the host computers uses individual intrusion protection system engines residing on individual ones of the host computers. Detecting unauthorised events from said transmissions uses the individual engines. Isolating a host computer from the computer network occurs when an unauthorised event is detected associated with that host computer.

According to an embodiment, an intrusion protection system and method protect host computers of a computer network from network intrusions. All inbound and outbound transmissions of individual host computers are monitored to detects any unauthorised events. The Once an unauthorised event is detected the inbound and outbound transmissions of a host computer are locked down, thereby isolating the host computer from the rest of the computer network. A global network security provider provides further security services remotely.

### BRIEF DESCRIPTION OF THE DRAWINGS

Further features of embodiments of the present invention will be readily apparent from the following detailed description of a non-limiting example, with reference to the accompanying drawings, in which:—

FIG. 1 is a schematic block diagram of a world-wide network connecting an intrusion protection system (IPS) according to one embodiment;

FIG. 2 is a schematic block diagram of a terminal connecting to the IPS within FIG. 1;

FIG. 3 is a schematic block diagram of the IPS engine within FIG. 2; and

FIG. 4 exemplifies an operating process of the IPS within FIG. 1.

### DETAILED DESCRIPTION

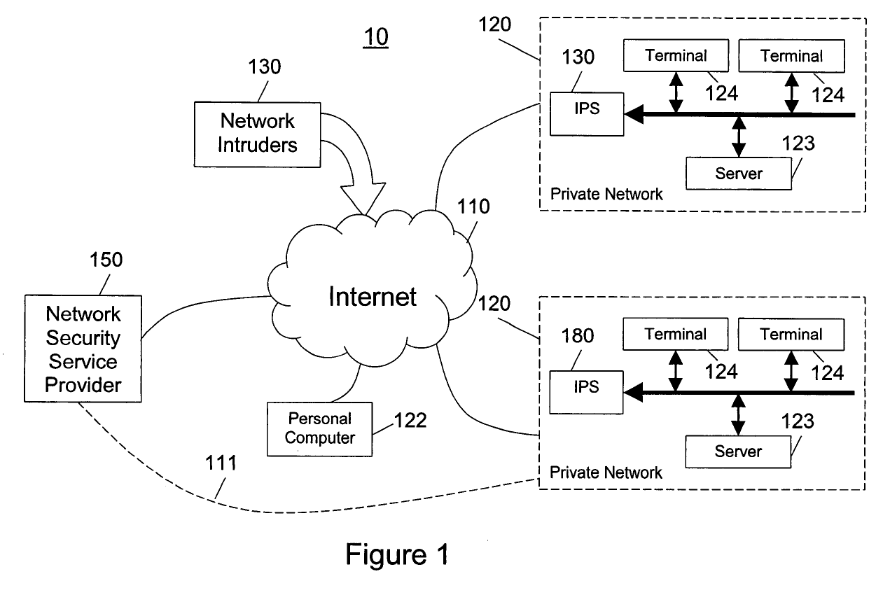

Referring to FIG. 1, there is shown a world-wide computer network 10 including a plurality of private networks 120, such as local area networks (LAN), wide area networks (WAN) or the like, and personal computers 122 connected with each other via the Internet 110 (or some other global or very wide area network). Each of the private networks 120 is formed by a plurality of terminals 124 hosted by at least one server 123. The world-wide network 10 further includes a network security service provider (NSSP) 150, which provides network security management services for the private networks 120 or personal computers 122.

The services provided by the NSSP 150 are subscription based, round-the-clock services. The services include: subscribers' endpoint assessment and cleansing, system policy consulting, system training, security surveillance and incident management, notification and countermeasures deployment, remote viewer for reviewing up-to-date security information on demand, and the like. The NSSP 150 enables security professionals to manage and enforce security policy centrally, right down to all the terminals 124 and servers 123 of the private networks 120 that have subscribed to the NSSP 150 services.

Network intruders 130 within the world-wide computer network 10 attempt hacking and attacking of the private networks 120 or personal computers 122 via unauthorised access, sending computer viruses or the like. Many such network intrusions occur during transaction activities between the private networks 120 and the Internet 110. Such intrusions may also occur within the private networks 120, for example unauthorised access via wireless facilities.

An intruder protection system (IPS) 180 is installed by the private networks 120, to control and monitor transactions within the private networks 120 traffic. The IPSs 180 are associated with the NSSP 150 via the Internet 120 or a dedicated, for instance a private communication line 111, to protect the respective private network 120 against network intruders 130. The NSSP 150 may have a full access and control of the IPS 180 remotely. Services that the NSSP 150 provide, in association with the IPS 180, include the provision of real-time management and the monitoring of the private network's 120 endpoint transactions.

The IPS 180 provides security management through host configuration enforcement and system usage profiling lockdown technology. The lockdown technology includes host-based detection and protection, file system and registry integrity monitoring and lockdown, system event logs auditing, host-based firewalls, a collective defence capability and the like. Should any of the private networks 120 be faced with attempted hacking threats, worms, viruses or the like, by network intruders 130, the IPS 180 responds, in association with the NSSP 150, to perform countermeasures to ensure such security threats are effectively managed. Such countermeasures and management are explained later in details. The IPS 180 may be installed in a centralised terminal of the private network 120, such as the server 123, or be a standalone device attached to the private network 120.

The IPS 180 provides multiple layers protection to the private network, such as the low-level data packet analysis, driver level protection, blocking of selected applications, and the like. This creates a multi-layered shield of protection for the terminals 124 and server(s) 123 of the private network 120.

At the data packet level, the IPS 180 monitors incoming traffic and proactively blocks any unauthorised access to the private network 120. Even any slightest attempt or foiling attempt made by a potential intruder to scan or collect information from the terminals 124 and the server(s) 123 of the private network 120 is detected and reported. All intrusions and attacks targeted at any of the terminals 124 or server(s) 123 of the private network 120 are stopped by the IPS 180 before they have a chance to cause any damage. The IPS 180 also provides a feature for tracing the network intruders 130. In addition, the IPS 180 can detect system faults quickly as it hosts intrusion detection system (IDS) technology enabling it to operate at near real time.

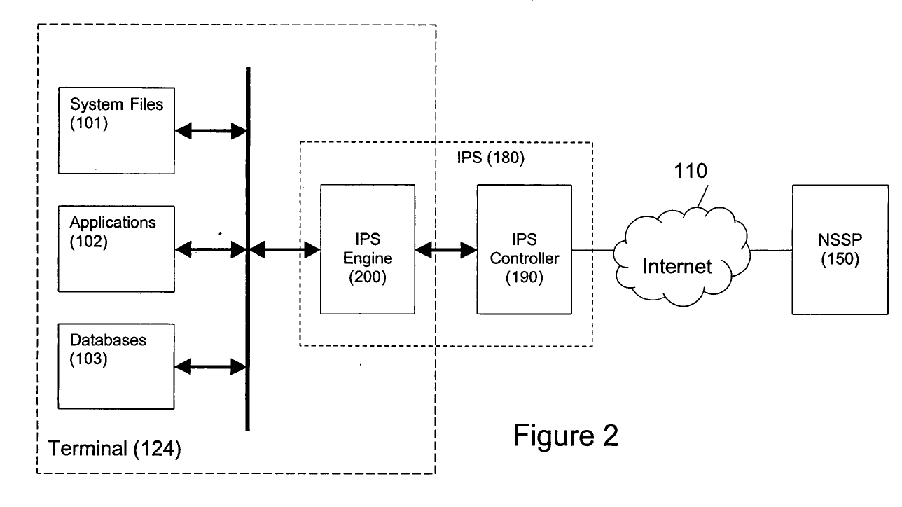

The IPS 180 is designed to protect all the terminals 124 and the server(s) 123 of the private network 120. The IPS 180 includes an IPS controller and a population of IPS engines. The individual IPS engines reside on the terminals 124 and the server(s) 123 of a private network 120, to enabling security features in association with the IPS controller. FIG. 2 illustrates one such terminal 124 of a private network 120, which has an IPS engine 200 residing therein and which is connected with a standalone IPS controller 190 (which is also connected to various other terminals). The private network 120 is subscribed to security services provided by the NSSP 150.

The terminal 124 includes an operating system 101, applications 102, and databases 103. The IPS engine 200 installed in the terminal 124 acts as a smart monitor and detector for possible hostile behaviour, attacks or intrusions on the operating system 101, applications 102 and databases 103 of the terminal 124. The IPS engine 200 provides security policy enforcement at different layers of the operating system 101. The function of the IPS engine 200 ranges from packet analysis at the terminal 124 to terminal lockdown and isolation from the private network 120.

During operation, the IPS engine 200 screens all inbound and outbound transmissions of the terminal 124 and reports to the IPS controller 190. When there is a viral infection or malicious hacker intrusion, or any abnormal activity at the terminal 124, the IPS engine 200 reports this to the IPS controller 190 and locks down all network communication channels and/or ports of the terminal 124, thereby isolating the terminal 124. This action blocks the inbound and outbound transmissions of the terminal 124, so as to prevent spreading of an infection or advance of the hacker attack on the infected terminal 124. Thereby no further spreading occurs within the private network 120.

The IPS engine 200 may attempt to deal with the threat itself, for instance activating a virus remover programs or the like, installed in the terminal 124. If the threat is resolved successfully, the isolation is removed, thereby allowing inbound and outbound transmissions again. However, if the threat cannot be solved by the IPS engine 200 itself or the virus remover program, the IPS engine 200 reports further to the IPS controller 190 and the terminal 124 remains isolated from the private networks 120.

The ISP 180 may further report to the NSSP 150 for solutions regarding the threat. After a cure for the threat is produced, the NSSP 150 updates virus signatures, software patches or the like of the ISPs 180 for removing the threat.

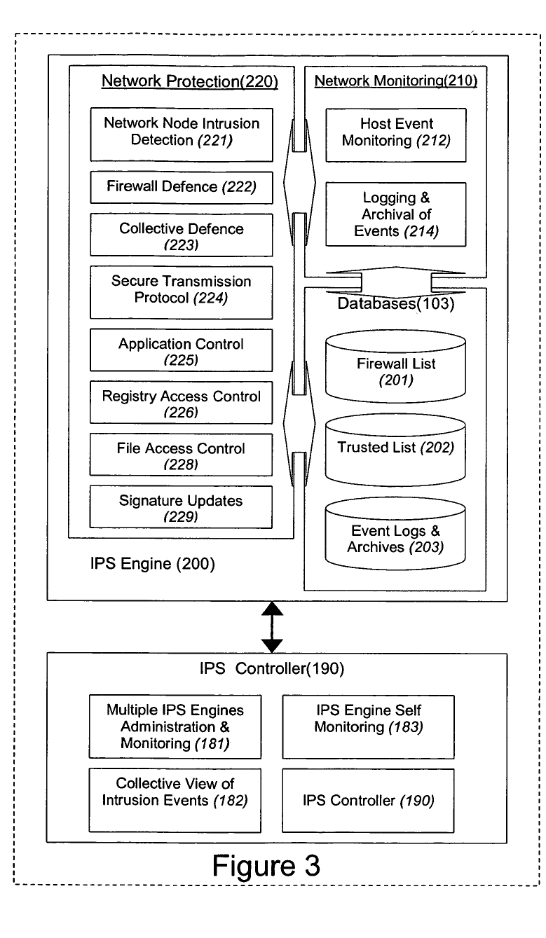

FIG. 3 illustrates a schematic function block diagram of an IPS controller 190 which is in communication with an IPS engine 200 installed on a terminal 124 or a server 123 of a private network 120. For ease of reference, the terminal 124 or server 123 hosting the IPS engine is hereinafter referred to as “the host”. The IPS controller 190 provides a multiple IPS engines administration and monitoring feature 181 for all IPS engines 200. There is no specific limit to the number of IPS engines 200 that can be controlled by a single IPS controller 190. From the IPS controller 190, a system administrator may be given privileged control of the IPS engines 200 remotely.

The IPS engine 200 has access to the databases 103 of the host for retrieving information. The databases 103 may include a firewall list 201, a trusted list 202 and a event logs and archives 203 for supporting features that may be provided by the IPS engine 200. The databases 103 may be updated automatically or manually by the IPS controller 190.

The features that the IPS engine 200 provides may be classified into two categories: network monitoring 210 and network protection 220. For network monitoring 210, the IPS engine 200 monitors the host terminal events 212 constantly and intercepts any suspicious internal event of the operating system 101. While monitoring, the IPS engine 200 logs and archives events 212, such as intrusion events, host events, application access events, data packet transmissions and traffic evidence. The logs and archives may be used for further analysis by a system administrator of the IPS 180. The logs and archives may also be sorted according to log type, event type, source, category, user or description for easy retriever.

Once the IPS engine 200 is enabled, the IPS engine 200 provides network protection 220, such as: network intrusion detection 221, firewall defence 222, collective defence 223, secure transmission protocol 224, application control 225, registry access control 226, file access control 228 and signature updates 229. Each of the network protections 220 may be dedicated to protect the hosts or host computers from a specific type of intrusion, for instance as described below.

The network node intrusion detection 221 looks at network traffic destined for the host non-promiscuously. The IPS engine 200 captures and analyses all the inbound and outbound packets that are protected. To identify potential attacks, the IPS engine 200 checks each packet against security signatures that have been loaded into the databases 103 of the host.

The network node intrusion detection 221 has the ability to identify types of intrusions. At the same time, the intrusions are reported to the IPS controller 190 directly. With the IPS controller 190, the network node intrusion detection 221 may further be optimised by utilising a state protocol table, which may be stored in the databases 103 of the host, to analyse the type and content of an active protocol on the host.

The firewall defence 222 works in tandem with the network node intrusion detection 221, the built-in firewall defence 222 mechanism allows automatic or manual blocking of intruders. It supports all kinds of transmission protocols, such as ICMP, TCP and UDP. A scheduled or permanent blockage may be configured with the IPS engine 200.

With the firewall defences 222, the IPS engine 200 captures every packet that the host receives. Generally, if the number of packets that match a unique pair of source target identifiers exceed a predefined threshold value, the engine will block subsequent packets from passing through to the host. Further, the IPS engine 200 also detects listening ports and allows the user at the host to block the listening ports manually.

Once a host is secured with the collective defence 223 of the IPS engine 200, the host in the private network 120 becomes self aware and fully equipped to defend against incoming attacks through early warning from its peers. When the host is attacked by an intruder, other IPS engines 200 secure their respective hosts from a similar intrusion. This results in all host computers being immunised against this intruder.

The collective defence 223 of the IPS engine 200 plays a critical role in isolating day-zero threats on the host server 123 and host terminals 124. When the collective defence 223 capability is enabled, potential intruders are pre-emptively blocked and, if vulnerabilities are exploited, they remain in containment within the infected host. This capability automatically prevents the propagation of attacks to the rest of the host of the private network 120. Thus when the hosts are secured with IPS engines 200, any new vulnerabilities and threats are not exploitable by viruses and hackers even though these hosts may contain the same vulnerability. With such a security measure in place, system administrators are relieved of the need for instant and critical patching, which in many instances are performed in an often-haphazard fashion, and is highly risky if not properly executed. Instead, such situation is presented with additional “grace” period required to properly test out new software patches and to schedule the patch cycles in an orderly manner, as such, avoiding unscheduled and haphazard server downtime and crashes.

The IPS controller 190 may also provide a secure transmission protocol 224 for providing the IPS engines 200 with a secure and encrypted channel for communicating with any nodes in the protected private network 120. The secure transmission protocol may support different cryptographic methods.

Application control 225 allows the system administrator to grant or deny specific applications network access. Under the application control 225, there are two protection modes, trusted and untrusted.

In the trusted mode, the host allows all network access by default and you can add rules to deny applications from having network access. In the untrusted mode, all network accesses external to the local area network (LAN) of the host is denied. Rules can be added to grant specific applications network access or set the IPS controller 190 to insert permission rules automatically when attempts at network access by applications are detected.

All subscriber IPSs 180 may receive regular signature updates 229 from NSSP 150 and keep all the IPS engines 200 updated with the latest known attack schemes. Updating of the signatures may be scheduled automatically in the IPS 180, or the system administrator may download the updates in a hassle-free and no-downtime environment. With the regular updates, the IPS controller 190 or the IPS engine 200 may trap activities by the latest known Trojan viruses and network worms and also protect the hosts from all known network worms.

Many viruses are known to modify and/or destroy system files of the operating system 101. By modifying system files, viruses hijack control of a terminal 124 and its network access. The file access control 226 provides file system integrity features such as write-protecting all or certain system files 101 and applications 102 against any unauthorised read/write. Write-protection modes such as read, write, create, and change attributes or the like-may be set to be active permanently or to be active only during a certain period automatically or manually.

The IPS engine 200 defines a plurality of flags, which allows administrators to customise file protection. Upon selection of a flag, the action as defined by the flag is executed. Table 1 shows examples of various flags that may be used.

TABLE 1

| Flag | Description |
|---|---|
| All | Applies all the protection flags to the files |
| Read | Prohibits the reading of files |
| Direct Read | Prohibits the direct read access of drives |
| Write | Prohibits the modification of files |
| Direct Write | Prohibits the direct write access of drives |
| Hide | Hides the files |
| Rename | Prohibits the renaming of files |
| Delete | Prohibits the deletion of files |
| Open | Prohibits the opening of files |
| Create | Prohibits the creation of files |
| Replace | Prohibits the replacing or renaming of files |
| Retrieve attributes | Prohibits the retrieval of the attributes of files |
| Change attributes | Prohibits the modification of the attributes of files |

The operating system 101 for the terminal 124, for example, has registry keys that store vital information of applications 102 installed. Spy-wares and Trojans manipulate registry keys without the end user's knowledge. Such stealth behaviour causes information leakage and damage to the host itself. Using the registry access control 227, these registry keys are automatically protected when the IPS 180 is activated. Once the registry keys are protected, only the IPS controller 190 has access rights to these protected registry keys. This prevents viruses and Trojans from modifying or deleting the start-up keys in the registry.

Similarly to the file access control 226, the IPS 180 defines a plurality of flags, which allows administrators to customise registry protection. Upon selection of the flags, the action as defined by the corresponding flag is executed. TABLE 2 shows examples of various flags and their description.

TABLE 2

| Flag | Description |
|---|---|
| All | Applies all the protection flags to the registry |
| Open Key | Prohibits opening of registry key |
| Create Key | Prohibits creation of registry key |
| Hide Key | Prohibits registry key from hiding |
| Hide Value | Prohibits registry value from hiding |
| Load Key | Prohibits loading of registry key |
| Set Value | Prohibits registry from setting value |
| Set ValueEx | Prohibits registry from setting valueEx |
| Query Value | Prohibits query of registry value |
| Query ValueEx | Prohibits query of valueEx |
| Unload Key | Prohibits registry key from unloading |
| Query Multiple Value | Prohibits registry key from query multiple value |
| Enumerate Key | Prohibits from reading registry key of a program |
| Enumerate Value | Prohibits from reading registry value of a program |
| Delete Key | Prohibits removing of registry key |
| Delete Value | Prohibits removing of registry value |

All inbound and outbound transmissions screened by the IPS engines 200 may be reported to the IPS controller 190 according to their respective categories, such as: network intrusion events, system host events, and application events. This collective view of intrusion events 182, in particular, may provide the system administrator with an immediate overview of intrusion events to the private network 120 or any of the server 123 and terminals 124 of the private network 120. This enables the system administrator to respond quickly to block off intruders.

The IPS controller 190 has the ability to monitor itself (IPS self monitoring 183) to ensure that the IPS 180 itself is functioning properly all the time. When it is detected that the IPS controller 190 is not running properly, the monitoring mechanism may self-restart the IPS controller 190.

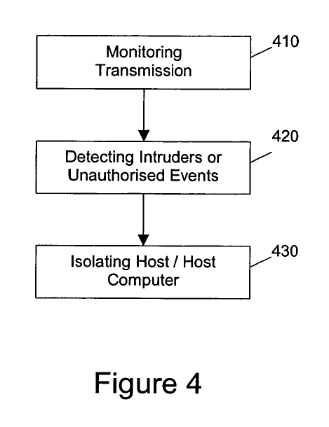

As illustrated in FIG. 4, the IPS 180 monitors all the inbound and outbound transmissions of the host or host computers (step 410). All IPS engine 200 are activated to protect the corresponding host or host computers. When any of the host encounters any intrusions or unauthorised events, such intrusions or events are detected by the IPS engine 200 (step 420) of the relevant host. The relevant host(s) is isolated from its network 120 (step 430) when any intrusions or unauthorised events is detected. No transmission is permitted between the relevant host(s) with its network 120, to protect the other host being infected by the similar threat.

Depending on specific requirements, each of the hosts/host computers may be configured to allow customised protection.

It will be understood by those skilled in the art that, even though numerous characteristics and advantages of various preferred aspects of the present invention have been set forth in the foregoing description, this disclosure is illustrative only. Other modifications may be made, especially in matters of structure, arrangement of parts and/or steps within the principles of the invention to the full extent indicated by the broad general meaning of the appended claims without departing from the scope of the invention.

1. An intrusion protection system (I PS) for protecting a computer network having a plurality of host computers from computer network intrusions, the system comprising:
an intrusion protection system controller; and
a plurality of IPS engines, controlled by the intrusion protection system controller, for monitoring and controlling inbound and outbound transmissions to the host computers; wherein
the IPS engines reside in respective ones of the host computers, and are arranged to isolate the transmissions of their host computers from the computer network automatically.

2. An intrusion protection system according to claim 1, wherein the intrusion protection system is in data communication with a network security provider.

3. An intrusion protection system according to claim 2, wherein the intrusion protection system is in communication with the network security provider via the Internet.

4. An intrusion protection system according to claim 2, wherein the intrusion protection system is in communication with the network security provider via a dedicated communication line.

5. An intrusion protection system according to claim 2, operable to be remotely controlled by the network security provider.

6. An intrusion protection system according to claim 1, wherein the intrusion protection system controller is operable to control the IPS engines remotely.

7. An intrusion protection system according to claim 1, wherein the IPS engines are arranged to detect unauthorized events from the transmissions.

8. An intrusion protection system according to claim 7, wherein the IPS engines are arranged to isolate the transmissions of their respective host computers from the computer network following the detection of an unauthorized event.

9. An intrusion protection system according to claim 8, wherein the IPS engines are arranged to attempt a fix following the isolation and to remove isolation once the fix is successful.

10. An intrusion protection system according to claim 8, wherein the IPS controller is arranged to attempt a fix following the isolation and to remove isolation once the fix is successful.

11. An intrusion protection system according to claim 7, arranged to notify all the IPS engines of an unauthorized event which is detected by at least one of the IPS engines.

12. An intrusion protection system according to claim 1, wherein an IPS engine resides in each host computer of the computer network.

13. An intrusion protection system according to claim 1, wherein the host computers comprise a plurality of computer terminals and one or more servers.

14. A method of protecting a computer network having a plurality of host computers from computer network intrusions comprising:
monitoring inbound and outbound transmissions of the host computers, using individual intrusion protection system engines residing on individual ones of the hose computers;
detecting unauthorized events from said transmissions, using the individual engines; and
isolating a host computer from the computer network, when an unauthorized event is detected associated with that host computer.

15. A method according to claim 14, futher comprising protecting at least some of the systems of the host computers.

16. A method according to claim 15, wherein systems of the host computers are protected based on the selection of one or more flags of a plurality of flags, which allows customized system protection.

17. A method according to claim 15, wherein the protected systems comprise files.

18. A method according to claim 15, wherein the protected systems comprise registries.

19. A method according to claim 14, further comprising communicating with a network security provider at a remote location.
